(19) United States
(12) Patent Application Publication
(10) Pub. No.: US 2011/0114058 A1
(43) Pub. Date: May 19, 2011

(54) HIGH EFFICIENCY NATURAL GAS/GASOLINE BI-FUEL ENGINES USING ON-DEMAND KNOCK CONTROL

(75) Inventors: Daniel R. Cohn, Cambridge, MA (US); Leslie Bromberg, Sharon, MA (US); John B. Heywood, Newtonville, MA (US)

(73) Assignee: ETHANOL BOOSTING SYSTEMS LLC, Cambridge, MA (US)

(21) Appl. No.: 12/774,815

(22) Filed: May 6, 2010

Related U.S. Application Data
(60) Provisional application No. 61/176,553, filed on May 8, 2009.

(51) Int. Cl. F02B 47/02; F02B 13/00; F02M 7/00

(52) U.S. Cl. 123/25 A; 123/575; 123/436

(57) ABSTRACT

A bi-fuel spark ignition engine is disclosed. The engine can operate on either gasoline, natural gas or a combination of the two. The amount of each fuel that is used by the engine is based on the engine's operating parameters, such as RPM and torque. In some embodiments, the operator can provide input, such as the availability of natural gas, which affects the operation of the engine. In some embodiments, an anti-knock agent is used to prevent knock at higher values of torque.

This application claims priority of U.S. Provisional Patent Application No. 61/176,553, filed May 8, 2009, the contents of which are incorporated by reference in its entirety.

### BACKGROUND

There is an increasing interest in the expanded use of natural gas for car and trucks because of its lower cost as compared to gasoline or diesel fuel, its lower green house gas emissions, lower hydrocarbon emissions and the increased supply available by using gas from shale. Natural gas can be used in either dedicated natural gas only engines or in bi-fuel engines that can operate on either natural gas or gasoline and are presently in use in light duty vehicles. These engines provide the driver with the option of using gasoline when natural gas in not available or more expensive. Bi-fuel engines can also provide the driver with extended range since the range with a given stored volume of natural gas is substantially less than that of gasoline. Bi-fuel engines are particularly important for expanding natural gas use beyond fleet vehicles, which use their own natural gas refueling system and can meet their operation goals without the option of gasoline operation. The use of bi-fuel natural gas/gasoline engines can significantly expand natural gas utilization through its use in non fleet light duty vehicles. Another important application is in long haul heavy duty trucks.

A drawback of present bi-fuel engines, relative to natural gas only engines, is the limitation on performance and efficiency resulting from the constraint of compression ratio and turbocharging imposed by the requirement to prevent knock when the engine is operated with gasoline. With an octane number of around 90, gasoline has a substantially lower knock resistance than natural gas, which can have an octane number of 130. As a result, present bi-fuel engines operate with less performance and efficiency than is possible when the engine is designed for operation with only natural gas. The knock constraint is particularly important for bi-fuel engines that must compete with diesel engines in heavy duty vehicle applications. It is highly desirable for these engines to provide the same efficiency and torque as diesel engines.

Moreover, even when bi-fuel engines are operated with natural gas, constraints on high compression ratio and turbocharging that are imposed by engine knock can prevent these engines from having the same torque and efficiency as a diesel engine. Operation at high pressure, such as with the use of high compression ratio and/or turbocharged operation, can be significantly constrained, albeit to a lesser degree than the case with gasoline, when the knock resistance quality of the available natural gas is low. Knock under these circumstances limits the exploitation of the higher knock resistance of natural gas that is provided by the higher octane number of natural gas, which is made mostly from methane. Pure, or neat, methane has an octane number of about 130.

For natural gas engines, the knock properties of the fuel is measured by the methane number, which measures the amount of reactive hydrogen in the fuel divided by the amount of reactive carbon in the fuel. The distribution of the Methane Number (MN) in natural gas in the US is shown in Table 1. In the US, the mean Methane Number of natural gas is about 90, with a minimum of about 73 and a maximum of about 96. The variation in methane number results in changes in the octane rating. FIG. 1 shows a relationship between the octane number and the methane number. In any case, the motor octane number of natural gas (115-135) is substantially higher than the octane number of gasoline (80-95).

TABLE 1
Distribution of methane number of natural gas in the US

| | | 10^{th} | | 90^{th} | |
|---|---|---|---|---|---|
| | Minimum | Percentile | Mean | Percentile | Maximum |
| Methane | 73.1 | 84.9 | 90 | 93.5 | 96.2 |
| Number | | | | | |

Because of the knock limitation, the energy efficiency of a conventional naturally aspirated, port fuel injected gasoline engine is typically 25-30% lower than that of a diesel engine. It would be desirable to remove this drawback, and operate a spark ignited bi-fuel engine at an efficiency that is comparable to a diesel engine. Gasoline engines are less expensive than diesel engines, partially because exhaust aftertreatment is considerably simpler and less expensive, through the use of three-way catalysts. In addition, the three-way catalyst is more robust for meeting stringent emission requirements and a spark ignition engine can provide higher RPM operation, resulting in higher power at a given level of torque.

### SUMMARY

A bi-fuel spark ignition engine is disclosed. The engine can operate on gasoline, natural gas or a combination of the two. The amount of each fuel that is used by the engine is based on the engine's operating parameters, such as RPM and torque. In some embodiments, the operator can provide input, such as the availability of natural gas, which affects the operation of the engine. In some embodiments, an anti-knock agent is used to prevent knock at higher values of torque.

### BRIEF DESCRIPTION OF THE DRAWINGS

FIG. 1 is a graph showing methane number as compared to octane number;

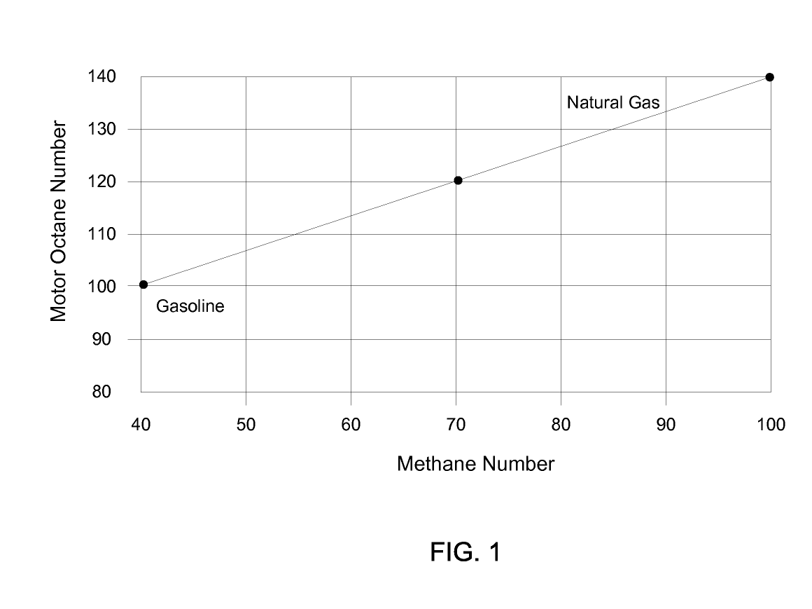

FIG. 2 is an illustration of a bi-fuel engine and controller;

FIG. 3 is a graph showing the fraction of natural gas (on an energy basis), at a given RPM, required to prevent knock in a spark ignition gasoline engine, as a function of the maximum torque of a representative heavy duty diesel engine;

FIG. 4 is an illustration of a bi-fuel engine with an anti-knock alcohol or alcohol/water tank, and the associated controller;

FIG. 5 is a graph showing the fraction of natural gas and methanol (on an energy basis), at a given RPM, required to prevent knock as a function of the maximum torque of a diesel engine;

FIG. 6 is an illustration of a bi-fuel engine, with a knock sensor that provides information to the controller in order to adjust the fraction of gasoline, natural gas and/or alcohol mixture used by the engine; and

FIG. 7 shows several options for use of different fuel fractions throughout the engine map.

### DESCRIPTION OF THE INVENTION

The lower efficiency drawback of bi-fuel engines can be alleviated by on-demand use of natural gas as an anti-knock fuel at higher values of torque, when the engine is mainly operated on gasoline. In addition, a greater amount of knock suppression can be obtained by on-demand use of a directly injected alcohol or alcohol-water mixture as an anti-knock additive, which is provided by a small additional tank.

The low cruising range (i.e. distance that can be travelled on one tankful of fuel) of natural gas fueled vehicles can be alleviated by operation which maximizes the use of gasoline when the torque is sufficiently low for the engine to operate with gasoline, thereby minimizing the consumption of natural gas. This concept also allows for the optional increased use of natural gas when it is available and when frequent refueling intervals do not represent a hardship to the operator.

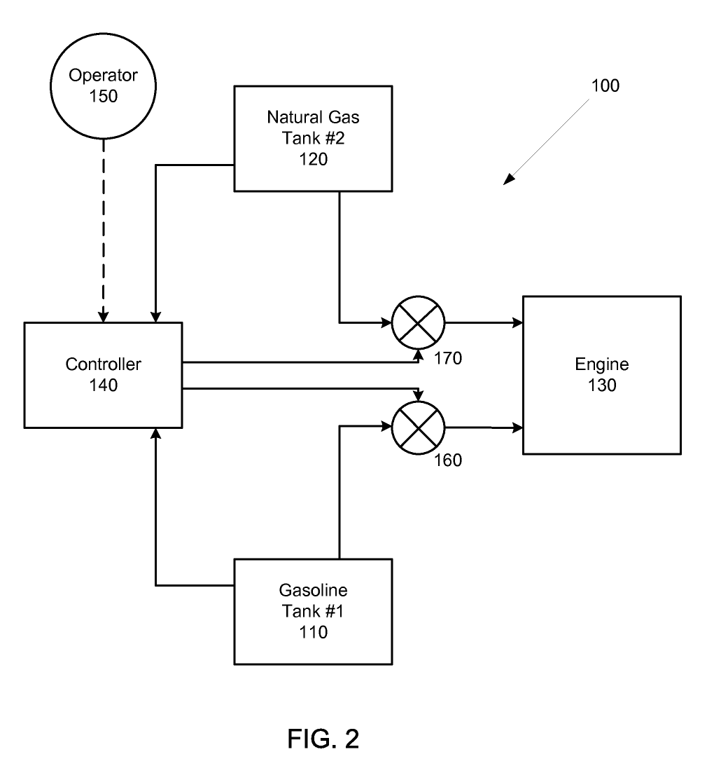

FIG. 2 shows one embodiment 100 of the present invention. Gasoline is provided by a first tank 110 and natural gas is provided by a second tank 120. While the term “natural gas” is used throughout this disclosure, it is understood that any fluid that contains methane may be used. The engine 130 can be fueled with natural gas, gasoline or both, at a rate determined by a control system 140. The control system 140 uses information from a fuel meter in both the gasoline and the natural gas tanks. It also uses information that could be provided by the operator 150. The operator 150 may or may not provide input to the controller 140 as indicated in FIG. 2. The controller provides signals to valves 160, 170 or other devices that regulate the amount of natural gas and gasoline, respectively, that is introduced into the engine 130.

At low torque, or when natural gas is expensive (instructed by the operator 150), and/or when extended range is desired (instructed by the operator 150), the engine 130 may operate mostly on gasoline, maximizing the gasoline consumption and minimizing the natural gas consumption. At conditions of higher torque, the engine 130 may use gasoline/natural gas mixtures, in order to use the larger octane of natural gas. In some embodiments, to minimize natural gas consumption, only as much natural gas as needed to prevent knock is used. As the load increases, an increased fraction of natural gas/gasoline ratio is used, as the knock requirements of the fuel typically increase with load (at a given RPM). Thus, the controller 140 may receive input, such as from the engine 130, providing information about the torque being exerted. Based on this information, the controller 140 may adjust the ratio of gasoline to natural gas that is introduced to the engine 130 by adjusting the inputs to valves 160, 170. In some embodiments, input from the operator 150 may also be used to vary the ratio of the two fuels as described above. Alternatively a knock sensor in the engine could be used to provide close-loop feedback on the amount of natural gas required.

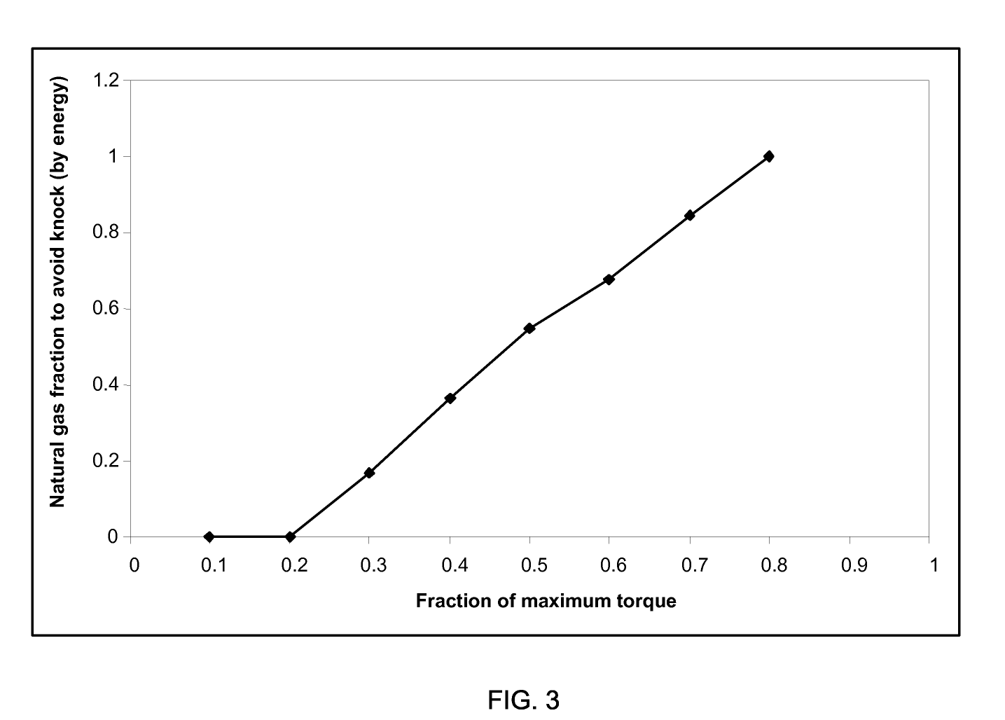

FIG. 3 shows an illustrative computer model calculation of the natural gas use, needed to prevent knock as a function or torque. The natural gas use is given as a fraction of the total fuel. The model employed by Blumberg et al. [Blumberg, Bromberg H. Kang and C. Tai, Simulation of High Efficiency Heavy Duty SI Engines Using Alcohol Direct Injection for Knock Avoidance, SAE document 2008-01-2447] was used to carry these calculations, and FIG. 3 shows the results of the calculations for the B-speeds of the European Stationary Cycle (ESC) test, applicable to heavy-duty engines. The calculation includes propane, butane and ethane in the natural gas in proportions that represent their “average” values present in US pipeline grade natural gas. The illustrative calculation in FIG. 3 is for a high compression ratio, turbocharged engine that might be used to provide the same torque and efficiency as a heavy duty diesel engine as described in the above reference. The figure shows that natural gas operation can provide a large increase in knock free torque relative to gasoline operation. However, the engine cannot operate without knock at the high torques (i.e. >75% of maximum torque) provided by the diesel engine even when entirely fueled by natural gas.

If the amount of natural gas is limited or not available, or is insufficient to provide the required knock resistance at the highest loads, knock suppression can be provided by on-demand direct injection of an anti-knock agent, such as alcohol or an alcohol water mixture, provided by a small additional tank. As discussed in U.S. Pat. Nos. 7,225,787 and 7,314,033, which are incorporated herein by reference in their entireties, directly injected anti-knock agents, such as alcohol or alcohol-water mixtures, can provide very strong knock suppression in a spark ignition engine due to the evaporative cooling when the liquid is transformed into a gas.

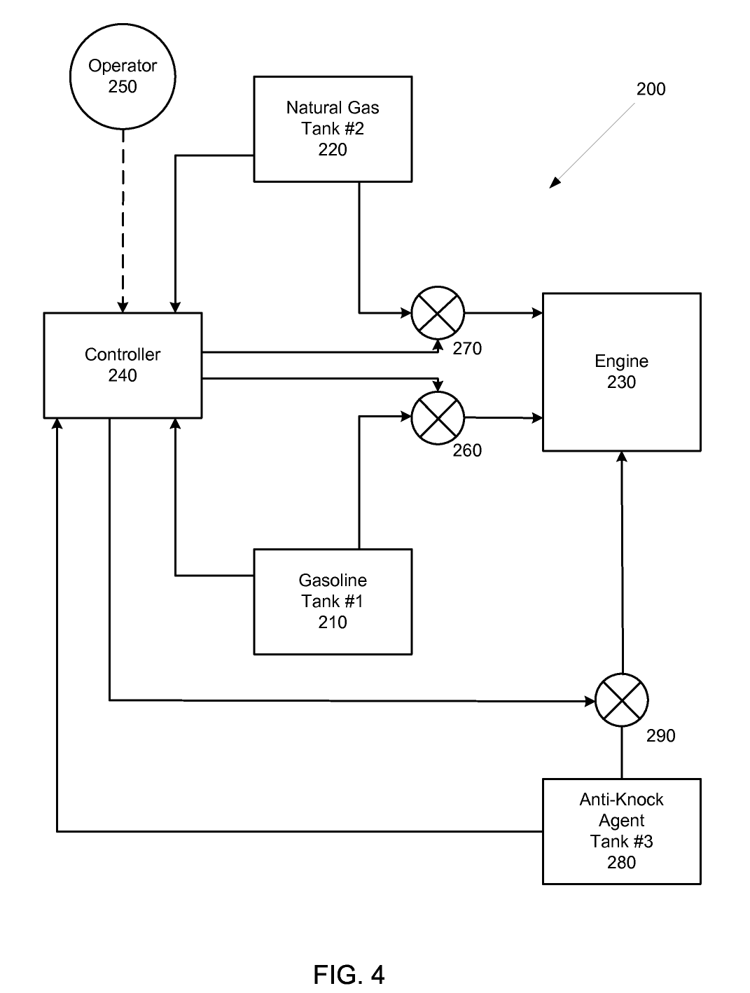

FIG. 4 shows a schematic of the fuel management system 200 utilizing an anti-knock agent. Three fuels (gasoline, natural gas and alcohol) are used. Each is stored in a separate tank. As described with respect to FIG. 2, gasoline stored in a first tank 210, while natural gas is stored in a second tank 220. Controller 240 uses information from the operator 250 and the engine 230 to control the amount of each fuel that is introduced into the engine 230. The controller 230 may use valves 260,270 to control the flow of natural gas and gasoline, respectively. In this embodiment, a third tank 280 is used to hold an anti-knock agent that is directly injected into the cylinders of engine 230. The controller 240 can also control the direct injection of the anti-knock agent via valve 290. The operator 250 informs the controller 240 how to run the engine 230, and the controller 240 decides where to operate using information based on the availability of gasoline, natural gas and/or anti-knock agent. In addition, the controller 240 uses information from the engine to control the flow of the gasoline, natural gas and anti-knock agent. This information from the engine may include, but is not limited to: engine speed, engine torque, air flow rate, fuel flow rates, cylinder pressure, knock sensor, oxygen sensor, coolant temperature.

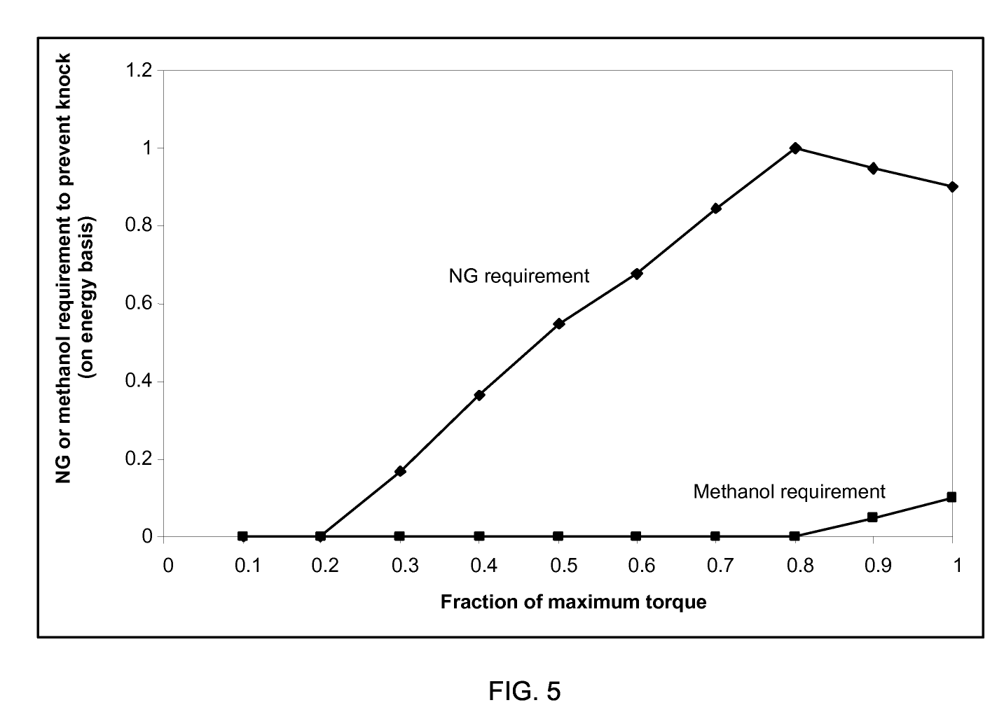

FIG. 5 shows calculations (at the B-speeds shown in FIG. 3), of the amount of directly injected anti-knock agent (i.e. an alcohol, such as methanol) required to achieve the higher loads not available by using pure natural gas. In this case, injection of a small amount of methanol prevents knock. When operating mainly on natural gas, knock can be avoided at the highest loads by the direct injection of 10% methanol (by energy). In other words, for a given speed (assumed to be 2000 RPM in FIG. 5), up to 20% of maximum torque, the engine can operate on gasoline. From 20%-80% of maximum torque, an increasing amount of natural gas must be used to prevent knock. Above 80% of maximum torque, a mixture of mostly natural gas, with the remainder being anti-knock agent is required. This graph was calculated for methanol as the high load antiknock fuel, but other alcohol or water-alcohol mixtures could also be used.

Because engine knock is less limiting at higher engine speed since the time allowed for autoignition (knock) is reduced, the relative amounts of natural gas and gasoline may be adjusted. At lower speeds, for a given torque level, the fraction of natural gas is higher than at higher speeds. Also, the need for the antiknock additive can be adjusted with speed.

FIG. 5 represents the case where the amount of anti-knock agent used is minimized. Very small fractions of antiknock fuel are required, because of the small time that the engine operates at the highest torque. However, it is possible to use anti-knock agents, such as alcohol or alcohol-water mixtures, at the lower torques, to minimize the rate of consumption of natural gas. In other words, rather than adding natural gas at 20% of maximum torque, anti-knock agent can be injected instead. In another embodiment, a combination of natural gas and anti-knock agent are used to reduce the amount of natural gas that is consumed.

The above calculations do not include the cooling effect when depressurizing the natural gas. The expansion cooling of the natural gas will have a positive impact on the anti-knock properties of the fuel. It is possible to inject the natural gas either in the manifold, or in the cylinder. In either case, the expansion cooling will reduce the temperature of the air/natural gas mixture and reduce the tendency of the engine to knock.

The knock suppression that is provided by the directly injected anti-knock agent, such as alcohol or alcohol-water mixture, allows increased engine efficiency through the use of high compression ratio, highly turbocharged/downsized engine, as well as engine downspeeding. This makes it possible to increase spark ignition engine efficiency to a level that is comparable to a diesel engine.

The natural gas, gasoline and directly injected anti-knock additive can thus be used in a variety of combinations. When the engine 230 is operating with gasoline supplied by a first tank 210 as the primary fuel, natural gas and/or the directly injected alcohol or alcohol-water mixture can be used to prevent knock at higher values of torque. When there is natural gas available in the second tank 220, it can be used for knock suppression throughout most of the torque range, thereby reducing the use of the directly injected anti-knock additive from a small third tank 280 to a very small amount, e.g. less than 0.5 gallons for every 100 gallons of gasoline, for port fuel injected gasoline and typical driving. If there is no natural gas available in the second tank 220 or if the operator 250 wishes to conserve the use of natural gas, all of the knock suppression can be provided by the directly injected anti-knock agent (i.e. alcohol or alcohol-water mixture fluid) from a small third tank 280. The use of natural gas as a knock suppressant which is added at higher values of torque can either be controlled by the operator 250 or automatically controlled by the controller 240.

Operation of the vehicle with simultaneous use of natural gas and gasoline and where the natural gas is used at higher values of torque to prevent knock can provide the benefits of:
significantly longer range than if natural gas alone is used
minimizes the use of the directly injected anti-knock additive

When natural gas from the second tank 220 is employed as the primary fuel rather than gasoline, the directly injected anti-knock additive is used to suppress knock at high values of torque and/or to compensate for the use of lower octane natural gas (when using natural gas with lower methane numbers). The consumption of the directly injected anti-knock additive can be very small (e.g. less than 1 gallon for every 100 gallons of natural gas equivalent gasoline energy) because of the high octane of the natural gas.

Options for the fueling system include port fuel injection of the gasoline, direct injection of the gasoline and port fuel injection of the natural gas.

The presence of the two fuels and the antiknock agent allows for flexibility of operation during transients. Thus, during startup, it may be best to use primarily natural gas to prevent the generation of non-methane hydrocarbon emissions during the cold start process (which constitutes a large fraction of the total hydrocarbon emission). Because the natural gas response is fast, it can minimize enrichment required during fast transients. Similarly, the directly injected antiknock fluid can also provide very fast response. Directly injected antiknock fluid can be adjusted for each cylinder, in order to minimize its consumption. In a multicylinder engine, knock constrains vary from cylinder to cylinder, mostly due to the variation of residuals among the cylinders.

There are a number of options for further reducing the amount of the knock suppression fluid. They include direct injection of gasoline, non-uniform injection of the knock suppression fluid so that it is concentrated in the peripheral region of the cylinder where knock is most likely to occur, increased use of EGR, increased use of spark retard, and engine up-speeding. Direct injection of gasoline is much more effective for a typical light duty vehicle driving cycle in contrast to a driving cycle with prolonged high torque operation as would be the case for heavy duty long haul trucks or vehicles during heavy towing.

Thus, as long as natural gas is available for use, the requirement for the directly injected alcohol or alcohol-water mixture could be limited to significantly less than 1 gallon for every 100 gallons of either gasoline or gasoline-energy-equivalent natural gas. With an appropriately sized tank, knock suppression fluid tank need only to be refilled once every 500 gallons for a light duty vehicle. The refill interval could be more frequent for a heavy-duty vehicle because of prolonged high torque operation. This could be mitigated by use of non-uniform alcohol injection to increase knock resistance.

In another embodiment of this invention, there is no capability for direct injection of knock suppression fluid. Only natural gas is introduced into the gasoline engine to prevent knock at levels of torque where it would otherwise occur. The gasoline could be either port fuel or directly injected. When natural gas is not available, premium gasoline (having higher octane than regular gasoline) could be used to compensate for reduced knock resistance. The natural gas/gasoline ratio in the engine could be limited to the amounts needed to prevent knock and can be determined by closed loop control using a knock detector. A closed loop control system would allow use of natural gas of varying octane levels. However, the maximum torque that the engine can deliver is lower than in the case with the antiknock fluid, as it is limited by knock.

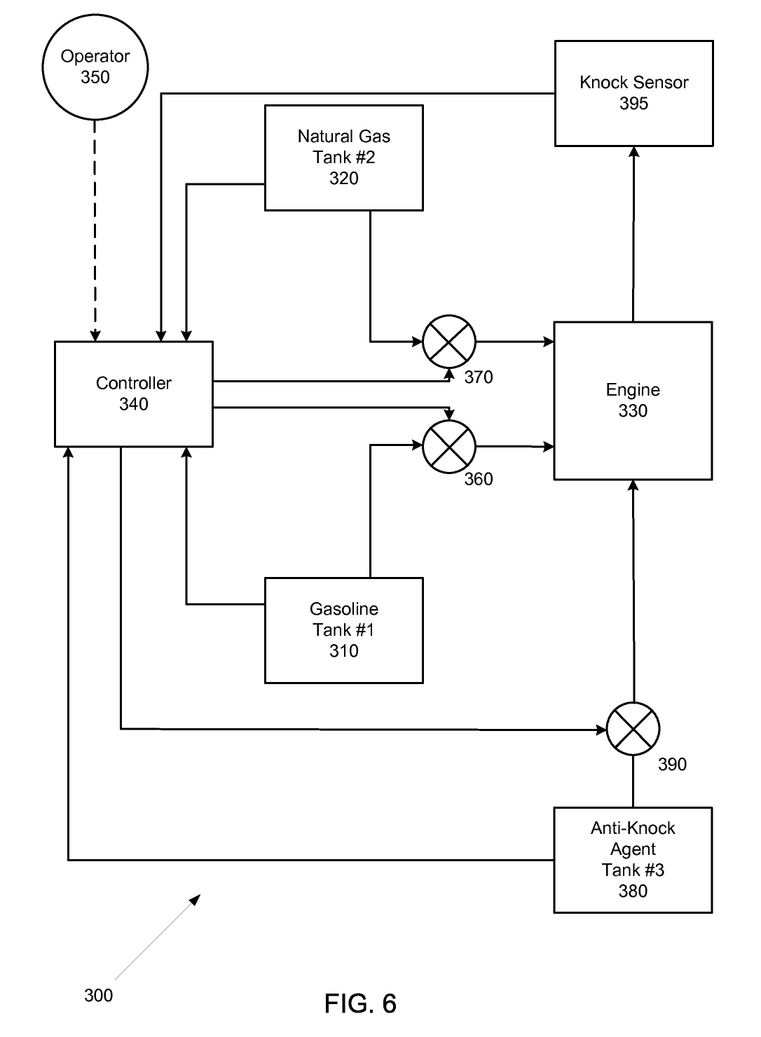

FIG. 6 shows a system 300 that uses closed loop control of knock, with an engine knock sensor 395 providing information, such as continuously, to the controller 340. The controller 340, in turn, adjusts the fractions of the gasoline, natural gas and/or alcohol mixture that are used. The controller 340 can use both forward looking and closed loop information to control the fuel ratios. The controller 340 can also use other sensors in the engine 330, such as misfire, temperature, engine speed, air temperature and other sensors in the vehicle to adjust the ratio of different fuels. The controller 340 adjusts the fuel fraction being introduced to the engine 330, by controlling the flow of gasoline from first tank 310, natural gas from second tank 320 and anti-knock agent from third tank 380. The flow control of gas, natural gas and anti-knock agent is done by controlling valves 360, 370, 390, respectively.

The octane level of natural gas can vary significantly due to variations in small concentrations of hydrocarbons, other than methane. When a natural gas fuel with a lower Methane Number (and, consequently, octane) is used, the natural gas/gasoline ratio would be higher at each value of torque. Maximum knock resistance would be obtained by operation with 100% or close to 100% natural gas at the highest level of torque.

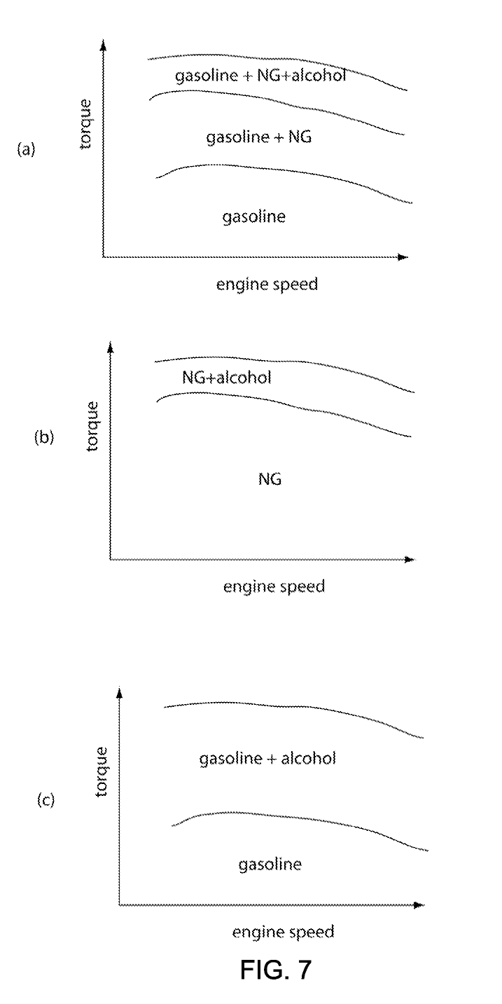

In one embodiment, an automatic or operator controlled system can be employed to use more natural gas than is needed for knock prevention and to control gasoline and natural gas consumption rates so as to maximize refueling convenience of the operator. For example, the operator may want to refill the gasoline tank at the same time as the natural gas refill or at some multiple of the natural gas refill time. When natural gas is available and convenient and the prices of natural gas are lower than those of gasoline, the operator may wish to maximize the consumption of the natural gas. The controller uses information provided by the operator to modify the consumption rate of natural gas. Some of these options are illustrated in FIG. 7.

For example, FIG. 7A shows a graph of torque versus engine RPM, where gasoline consumption is maximized by using at least some gasoline at every point in the engine map. At lower torques, only gasoline is introduced into the engine. At middle torque values, natural gas is used in conjunction with gasoline. At the higher values of torque, an anti-knock agent is also introduced, so that all three fuels are used.

FIG. 7B shows a graph of torque versus engine RPM, where natural gas consumption is maximized. In this embodiment, natural gas is used at lower and middle values of torque exclusively. An anti-knock agent is introduced only at higher values of torque.

FIG. 7C shows a graph of torque versus engine RPM, wherein natural gas consumption is minimized. In this embodiment, gasoline is used at lower values of torque, and an anti-knock agent is used at medium and higher levels of torque.

In the case where a high compression ratio engine has the capability for high turbocharging, such as with a compression ratio of 12 or more, and the vehicle does not have the capability for direct injection of alcohol, a control system which reduces the maximum level of turbocharging and/or increases spark retard can be used to allow drivability, albeit at lower maximum torque when there is no natural gas available and the engine is operated on gasoline alone.

The natural gas can be in the form of Compressed Natural Gas (CNG) or Liquefied Natural Gas (LNG).

In addition, it would be possible to fill the primary gasoline tank with an alcohol, for flex-fueled cars. In this case, the requirement of natural gas to prevent knock is decreased. Care needs to be taken that water is not accidentally introduced into the gasoline tank for conditions where there would be phase separation between the gasoline in the tank and the water-alcohol mixtures.

In addition to natural gas, the above considerations apply to the other gaseous fuels that contain methane, or that contain propane or propane blends. These fuels may be liquids or gasses.

In another embodiment, the directly injected anti-knock agent from the third tank does not contain alcohol and is instead water or a mixture of water and some liquid that is not alcohol.

The embodiments described above could be used in stationary engines as well as engines in vehicles. These engines could be used for decentralized electricity production for industry, commercial buildings and homes.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A spark ignition engine where gasoline is introduced from a first fuel tank and, where, for a first torque range, natural gas is introduced from a second fuel tank and where, for a second torque range, a anti-knock agent is directly injected from a third fuel tank.

2. The spark ignition engine of claim 1, wherein there is a torque range where only said natural gas is used to prevent knock.

3. The spark ignition engine of claim 1, wherein there is a torque range where only said anti-knock agent is used to prevent knock.

4. The spark ignition engine of claim 1, wherein there is a torque range where both natural gas and said anti-knock agent are used to prevent knock.

5. The spark ignition engine of claim 1, wherein said gasoline is port fuel injected.

6. The spark ignition engine of claim 1, wherein said gasoline is directly injected to a cylinder of said engine.

7. The spark ignition engine of claim 1, wherein an operator can control the rate of natural gas usage.

8. A spark ignition engine where gasoline is introduced from a first source and natural gas is introduced into said engine from a second source, and wherein said engine would knock without the introduction of said natural gas.

9. The spark ignition engine of claim 8, wherein the ratio of said natural gas to said gasoline increases with increasing torque.

10. The spark ignition engine of claim 9, wherein natural gas of various octane levels is used and wherein said ratio of natural gas to gasoline is changed to insure that knock is prevented.

11. The spark ignition engine of claim 8, wherein a greater amount of natural gas is used than is needed to prevent knock.

12. The spark ignition engine of claim 11, wherein the rate of natural gas use is determined by an operator.

13. A spark ignition engine and fuel system comprising:
a spark ignition engine;
a first fuel source for providing gasoline to said spark ignition engine; and
a second fuel source for providing a fluid or gas which includes methane to said spark ignition engine and wherein said engine is simultaneously fueled with said gasoline and said methane, and wherein the amount of said methane is varies so as to prevent knock.

14. The spark ignition engine and fuel system of claim 13 wherein the ratio of said methane to said gasoline increases with increasing torque.

15. The spark ignition engine and fuel system of claim 13, wherein closed loop control is used to minimize the amount of said methane that is consumed.

16. The spark ignition engine and fuel system of claim 13, wherein said engine is turbocharged.

17. The spark ignition engine and fuel system of claim 13, wherein said gasoline is port fuel injected.

18. The spark ignition engine and fuel system of claim 13, wherein said gasoline is directly injected into a cylinder of said engine.

19. The spark ignition engine and fuel system of claim 13 wherein regular gasoline is used when natural gas is employed and premium gasoline is used when it is not employed.

20. The spark ignition engine and fuel system of claim 13, further including a source of anti-knock agent which is directly injected into a cylinder of said engine.

21. The spark ignition engine and fuel system of claim 20, wherein the amount of anti-knock agent is varied so as to prevent knock.

22. A spark ignition and fuel system comprising:
a first tank containing gasoline;
a second tank containing a gas or fluid which includes methane;
and a third tank containing an anti-knock agent which is directly injected into a cylinder of said engine, and where said engine can be operated on either a combination of gasoline and methane, a combination of gasoline and anti-knock agent, a combination of gasoline, methane and anti-knock agent, or a combination of methane and anti-knock agent.

23. The spark ignition engine and fuel system of claim 22 wherein the ratio of methane to gasoline is varied so as to prevent knock.

24. The spark ignition engine and fuel system of claim 22, wherein the ratio of anti-knock agent to gasoline is varied so as to prevent knock.

25. The spark ignition engine and fuel system of claim 22, wherein the ratio of anti-knock agent to methane is varied so as to prevent knock.

26. The spark ignition engine and fuel system of claim 22, wherein the operator controls the relative rates of methane and gasoline consumption.

27. The spark ignition engine and fuel system of claim 22, wherein said engine is operated at a compression ratio of 12 or more and is turbocharged.

28. The spark ignition engine and fuel system of claim 22, wherein said fluid comprising methane comprises natural gas, wherein said natural gas has a range of octane numbers and wherein the ratio of anti-knock agent to natural gas at a given value of torque is increased when the octane number of said natural gas is lowered.

29. The spark ignition engine and fuel system of claim 22, wherein an operator of a vehicle comprising said engine determines the relative amounts of gasoline and methane use.

30. The spark ignition engine and fuel system of claim 22, further comprising a knock sensor, used with a controller in a closed loop control system to adjust the relative amounts of gasoline, methane and anti-knock agent.

31. The spark ignition engine and fuel system of claim 30, wherein said anti-knock agent comprises water, and further comprising a misfire sensor which is used to limit the amount of anti-knock agent that is injected into said engine.

32. The spark ignition engine and fuel system of claim 22 wherein said second tank contains natural gas comprising methane.

33. A spark ignition engine and fuel system comprising
a first tank containing gasoline;
a second tank containing a fluid comprising methane; and
a third tank containing water which is directly injected into a cylinder in said engine, and wherein said engine can be operated with gasoline and directly injected water, or gasoline and a gas or fluid which includes methane, or fluid comprising methane and directly injected water, or gasoline, fluid comprising methane and directly injected water, and wherein the ratios of said gasoline, methane and water are controlled so as to avoid knock.
